(19) United States
(12) Patent Application Publication
(10) Pub. No.: US 2002/0075682 A1
(43) Pub. Date: Jun. 20, 2002

(54) Structure of artistic table lamp

(76) Inventor: Mei-Lu Lin, Feng-Yuan City (TW)

Correspondence Address: MEI-LU LIN, P.O. Box 697, Feng-Yuan City, 420, TW

(21) Appl. No.: 09/738,930

(22) Filed: Dec. 14, 2000

(51) Int. Cl. F21S 4/00; F21V 21/116

(52) U.S. Cl. 362/252; 362/410

(57) ABSTRACT

A structure of artistic table lamp includes a lamp holder composed of a post and a plurality of branchs of hollow interior each having a slit along the length, a lamp stand on the bottom of the post and a socket on the top of each of the branchs for disposing a string of Christmas light therein and protect by a plurality of rail belts. It is characterized that this artistic table lamp can be made into a variety of shapes such as a sportsman.

### BACKGROUND OF THE INVENTION

The present invention relates to Christmas light and more particularly to a structure artistic table lamp made in combination with a string of Christmas light.

Conventional table lamp (as shown in FIG. 1) comprises a lamp holder 1 on a lamp base 2. The holder 1 has three branchs each including a drip pan 3 on the top for burning the candles 4 on it. Because the burning candle has a danger of catching fire people trend to use electric lamp instead of the candle. However, this lamp holder 1 is usually in solid structure and can not dispose an electrical wire therein so that it could not combine with an electric lamp.

### SUMMARY OF THE PRESENT INVENTION

The present invention has a main object to provide a provide a structure of artistic table lamp which can be combined with a string of Christmas lights.

Another object of the present invention is to provide a structure of artistic table lamp in which all the branchs of the holders and the drip pans have a slit to facilitate the electric wires of a string of Christmas lights to dispose therein.

Sill another object of the present invention is to provide a structure of artistic table lamp in which has a plurality of rail belt inserting into the slits in order to protect the electric wire from breaking off the slits.

Further object of the present invention is to provide a structure of artistic table lamp which can be molding into variety of shapes.

The present invention will become more fully understood by reference to the following detailed description thereof when read in conjunction with the attached drawings.

### BRIEF DESCRIPTION OF THE DRAWINGS

FIG. 1 is an elevational view to show a table lamp of a prior art,

FIG. 2 is an elevational view to show an artistic table lamp of the preferred embodiment according to the present invention,

FIG. 3 is an exploded perspective view to show partially the lamp holder of the present invention,

FIG. 4 is a perspective view to show the combination of FIG. 3,

FIG. 5 is a sectional view to show the relationship between the lamp holder, the drip pan and the electric wire,

FIG. 6 is a sectional view to show the rail belt engaged with the slit,

FIG. 7 is a plane view to show a string of Christmas lights combinable with the artistic table lamp,

FIG. 8 is an elevational view to show another shape of the artistic table lamp, and

FIG. 9 is a sectional view of an alternate embodiment of the lamp holder.

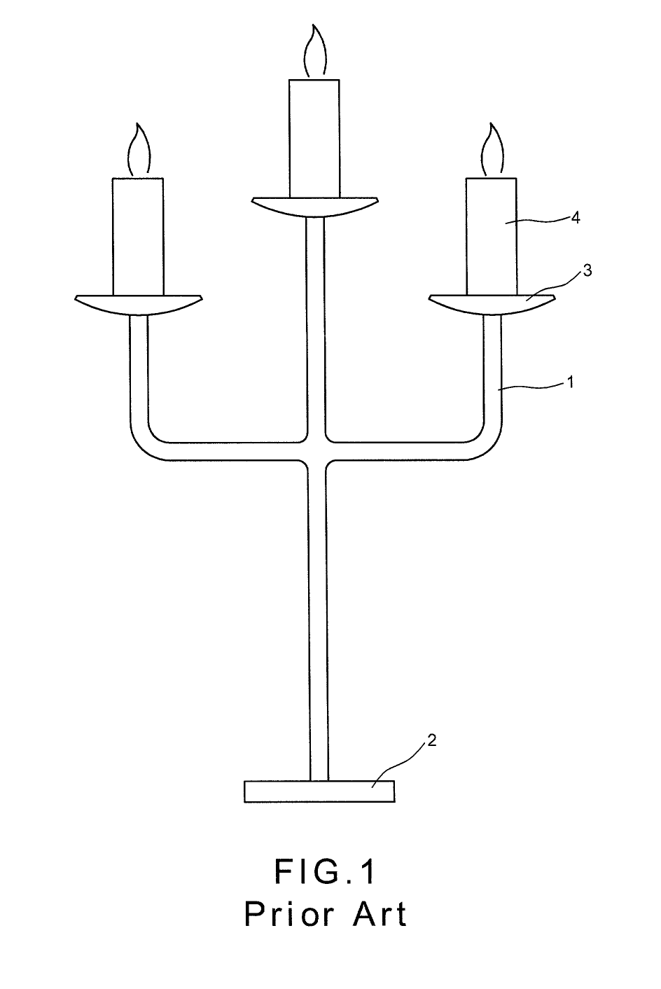

### DETAILED DESCRIPTION OF THE PREFERRED EMBODIMENT

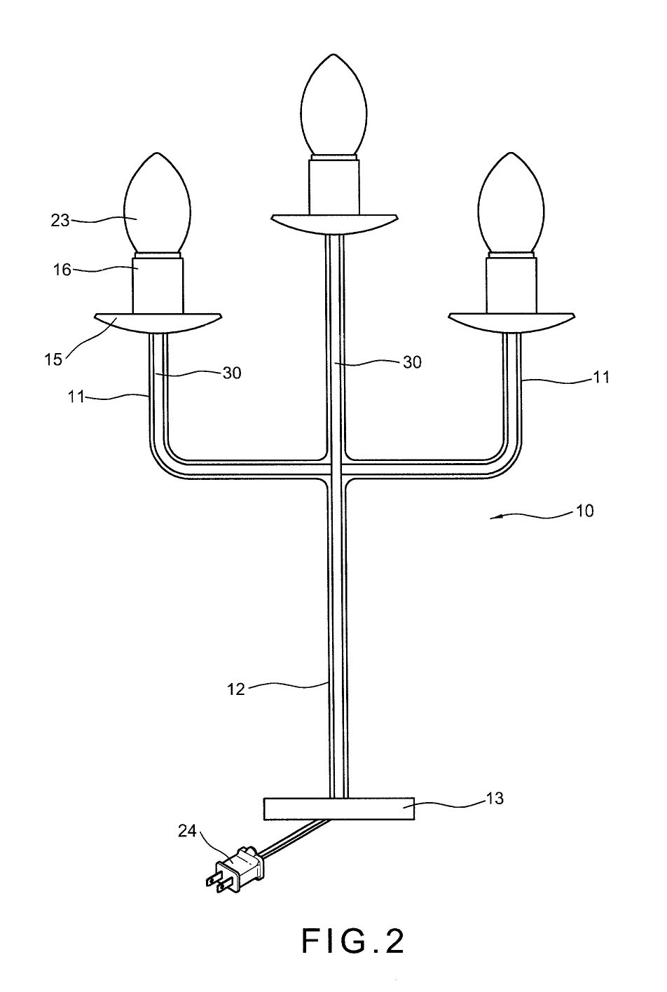

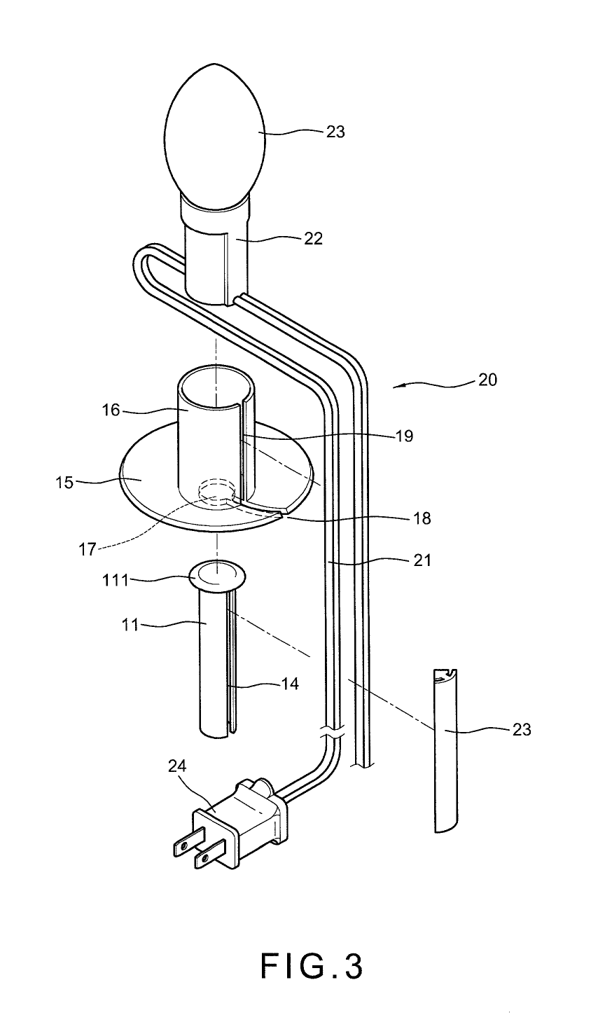

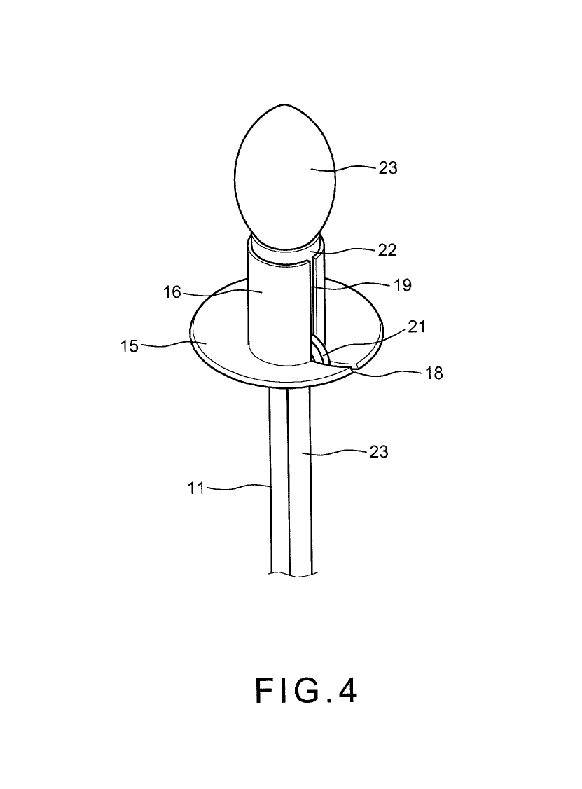

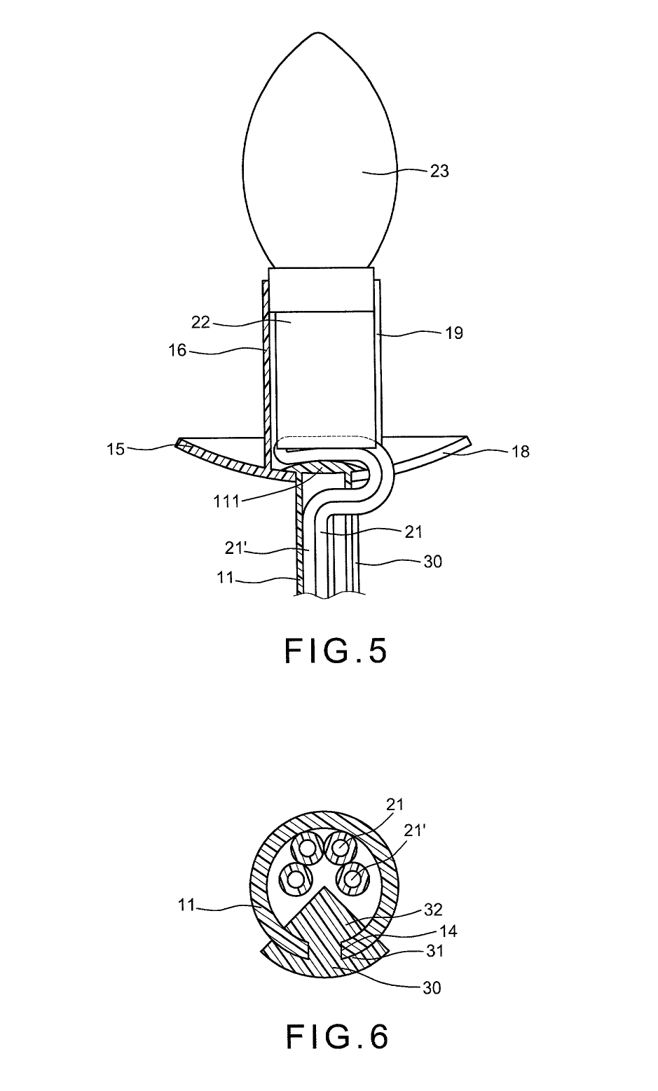

With reference to FIGS. 2, 3 and 4 of the drawings, the structure of artistic table lamp of the present invention comprises generally a lamp holder which is composed of a post 12 and a pair of branchs 11, a lamp stand 13 on the bottom. Both the post 12 and the branchs 11 are of hollow interior and each has a slit 14 axially formed in an outer periphery along the length thereof by which a string of Christmas lights enables to enter into the post 12 and the branchs 11 and an annular flange 111 on the top to pressed insert into a central bore 17 of a drip pan 15 which has a radial slit 18 in one side communicating to the central bore 17 and a socket 16 integrally projected upward from the top center of the drip pan 15 and also having an axial slit 19 in a peripheral wall along the length thereof and communicating with the radial slit 18 of the drip pan 15. The socket 16 can receive a base 22 of a Christmas light which has a bulb 23 in the top of the base 22. After the electric wires 21 of the string of Christmas lights insert into the post 12 and the branchs 11, each of the slits 14 is covered by a rail belt 30 of triangular section (as show in FIGS. 5 and 6). The rail belt 30 has a pair of longitudinal slots 31 engageable with the slits 14 and a stop member 32 for preventing the wires 21 from breaking off the slit 14. The string of Christmas light has also a plug 24 at lower end of the wires 21 under the lamp stand 13.

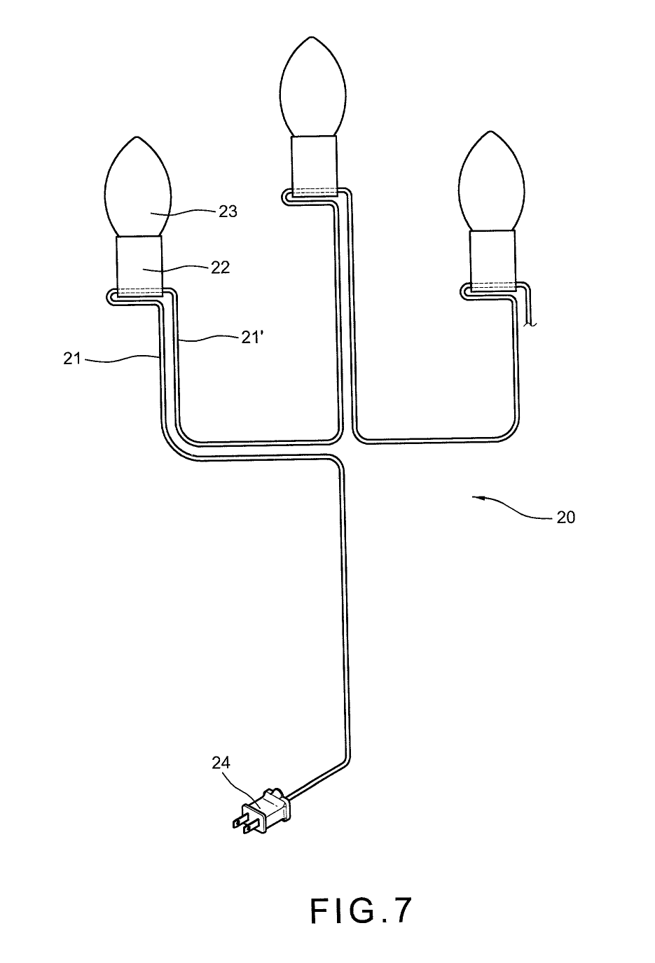

Referring to FIG. 7. before the combination of the string of Christmas lights with the table lamp, the length of the wires 21 and 21′ must be precedingly decided. Then insert the wire 21 into the slit 14 of the post 12 and the branch 11 and engage the base 22 of the Christmas light into a first socket and then insert the wire 21′ into the same branch and the other branchs 11 circuitously. After all the bases 22 of the Christmas lights are engaged with the sockets 16. Then turn the wire 21′ backward until it joins with the beginning point of the wire 21 and connected to the plug 24 which will connect to an external power source.

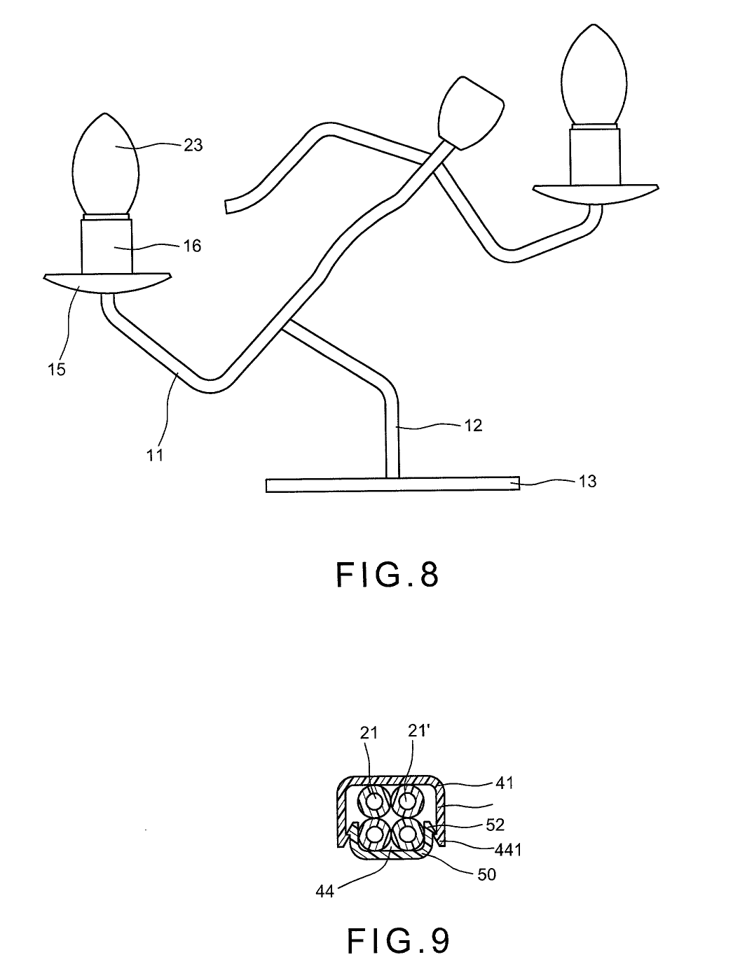

FIG. 8. the artistic table lamp can be mold into a variety of shapes such as a sportsman.

Referring to FIG. 9, an alternate embodiment of a post and branchs 40 is provided. The post on branchs 40 has a hollow interior rectangular body 41 and a slit 44 which a pair of inward hooks 441 at two ends. A rail belt 50 of U-shaped section made engageable with the slit 44 has a pair of outward hooks 52 made engageable with the inward hooks 441 of the post or branchs 40. Because of that the rail belt 50 is elastic, the engagement of the hooks 441 and 52 will be very secure to prevent the wires 21 and 21′ from breaking off the slit 44.

The specification relating to the above embodiment should be construed as exemplary rather than as limitative of the present invention, with many variations and modifications being readily attainable by a person of average skill in the art without departing from the spirit or scope thereof as defined by the appended claims and their legal equivalents.

I claim:

1. A structure of artistic table lamp comprising:
a lamp holder which is composed of a hollow interior post and a plurality of hollow interior branchs communicating with each other, said branchs each having an annular flange on top for pressedly engaging with a central bore of a drip pan each of which has a radial slit communicating with the central bore and a socket centrally projected upward from top of the drip pan to receive a lamp from a string of Christmas lights, an axial slit longitudinally formed in a peripheral wall of each of the branchs and the post for inserting electric wires of the spring of Christmas light into the branchs and the post, a lamp stand on bottom of the post and a plug connecting the electric wire under the lamp stand;
a plurality of flexible rail belts of triangular section covering the slits of the post and the branchs respectively, said rail belt each having a pair of longitudinal slots engaged with edges of the slits and a stop member to prevent the electric wires from breaking off the post and the branchs.

2. The structure as recited in claim I wherein said table lamp can be made into variety of shapes such as a sportsman.

3. The structure as recited in claim I further has a hollow interior rectangular lamp holder composed of a post and plurality of branchs each having a slit longitudinally formed in a wall along the length thereof, said slits each having a pair of inward hooks formed along two lateral edges thereof and a plurality of elastic rail belt of U-shaped section covering the slits each having a pair of outward hooks longitudinally formed along two edges made engageable with the inward hooks of the slits.
